(19) United States
(12) Patent Application Publication
(10) Pub. No.: US 2021/0287518 A1
(43) Pub. Date: Sep. 16, 2021

(54) INFORMATION PROCESSING APPARATUS, INFORMATION PROCESSING SYSTEM, METHOD OF PROVIDING INFORMATION, AND NON-TRANSITORY RECORDING MEDIUM

(71) Applicants: HAJIMU IKEDA, KANAGAWA (JP); TOSHIHIRO ATSUMI, KANAGAWA (JP); SHOTARO KOMOTO, KANAGAWA (JP); HIROTO SUMITANI, KANAGAWA (JP); HARUO NISHIMURA, KANAGAWA (JP)

(72) Inventors: HAJIMU IKEDA, KANAGAWA (JP); TOSHIHIRO ATSUMI, KANAGAWA (JP); SHOTARO KOMOTO, KANAGAWA (JP); HIROTO SUMITANI, KANAGAWA (JP); HARUO NISHIMURA, KANAGAWA (JP)

(73) Assignee: Ricoh Company, Ltd., Tokyo (JP)

(21) Appl. No.: 17/189,761

(22) Filed: Mar. 2, 2021

(30) Foreign Application Priority Data
Mar. 11, 2020 (JP) 2020-041703

(51) Int. Cl. G08B 21/18; G06K 9/00; H04N 7/18; G01J 5/00

(52) U.S. Cl. CPC G08B 21/182; G06K 9/00771; G06K 9/00369; G01J 2005/0077; H04N 7/18; G01J 5/0025; G06K 9/00342

(57) ABSTRACT

An information processing apparatus includes circuitry to acquire image data related to a user who uses a piece of equipment and indicating a state of the user. The circuitry stores, in a memory, setting information in which an item of time zone including one or more time zones for which the image data is captured, an item of determination result including one or more determination results in each of the one or more time zones, and an item of notification details being set according to one of the one or more time zones and one of the one or more determination results, are associated with each other. The circuitry determines whether to transmit a notification indicating the state of the user based on the image data and the setting information and, when determining to transmit the notification, determines the notification details based on the image data and the setting information.

### CROSS-REFERENCE TO RELATED APPLICATION

This patent application is based on and claims priority pursuant to 35 U.S.C. § 119(a) to Japanese Patent Application No. 2020-041703, filed on Mar. 11, 2020, in the Japan Patent Office, the entire disclosure of which is hereby incorporated by reference herein.

### BACKGROUND

### Technical Field

Embodiments of the present disclosure relate to an information processing apparatus, an information processing system, a method of providing information, and a non-transitory recording medium.

### Related Art

In facilities such as medical facilities and long-term care facilities, an information providing system that provides information on a user who uses a bed in a facility is used. The information to be provided indicates a state of the user, such as for example, a state of sleeping, getting up, or getting out of the bed.

For example, there is known information processing system that detects a state of a user, who uses a bed in a facility, by using temperature image data related to the user and notifies a predetermined notification destination of information indicating the state of the user.

### SUMMARY

An exemplary embodiment of the present disclosure includes an information processing apparatus including circuitry. The circuitry acquires image data related to a user who uses a piece of equipment and indicating a state of the user. The circuitry stores, in a memory, setting information in which an item of time zone including one or more time zones for which the image data is captured, an item of determination result including one or more determination results in each of the one or more time zones, and an item of notification details including notification details being set according to a combination of one of the one or more time zones and one of the one or more determination results, are associated with each other. The circuitry determines whether to transmit a notification related to the state of the user based on the image data and the setting information. The circuitry determines the notification details based on the image data and the setting information in response to a determination result indicating to transmit the notification.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an illustration of an example of a system configuration of an information processing system according to one or more embodiments;

FIG. 2 is an illustration of another example of a system configuration of an information processing system according to one or more embodiments;

FIG. 3A and FIG. 3B are diagrams each illustrating an example of an arrangement of beds and cameras, according to one or more embodiments;

FIG. 4A and FIG. 4B are diagrams each illustrating an example of a detection area according to one or more embodiments;

FIG. 5A to FIG. 5F are illustrations each for explaining a determination condition and an example of a determination result according to one or more embodiments;

FIG. 6 is a block diagram illustrating a hardware configuration of a computer according to one or more embodiments;

FIG. 7 is a diagram illustrating an example of a functional configuration of an information processing apparatus according to one or more embodiments;

FIG. 8A to FIG. 8C are diagrams each illustrating an example of a table of information managed by an information processing apparatus according to one or more embodiments;

FIG. 9A and FIG. 9B are diagrams each illustrating an example of a table of information managed by an information processing apparatus according to one or more embodiments;

FIG. 10 is a diagram illustrating an example of a setting screen according to one or more embodiments;

FIG. 11 is a diagram illustrating an example of a setting screen according to one or more embodiments;

FIG. 12 is a flowchart illustrating an example of process performed by an information processing apparatus according to one or more embodiments;

FIG. 13 is a sequence diagram illustrating an example of a process performed by an information processing system according to one or more embodiments;

FIG. 14 is a diagram illustrating an example of a display screen according to one or more embodiments;

FIG. 15 is a diagram illustrating an example of a table of a setting information according to one or more embodiments;

FIG. 16 is a diagram illustrating another example of a table of a setting information according to one or more embodiments; and

FIG. 17 is a sequence diagram illustrating an example of a process performed by an information processing system according to one or more embodiments.

The accompanying drawings are intended to depict embodiments of the present invention and should not be interpreted to limit the scope thereof The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of several embodiments of the present disclosure with reference to the attached drawings.

System Configuration

A description is given below of an information processing system 100 according to one of the embodiments.

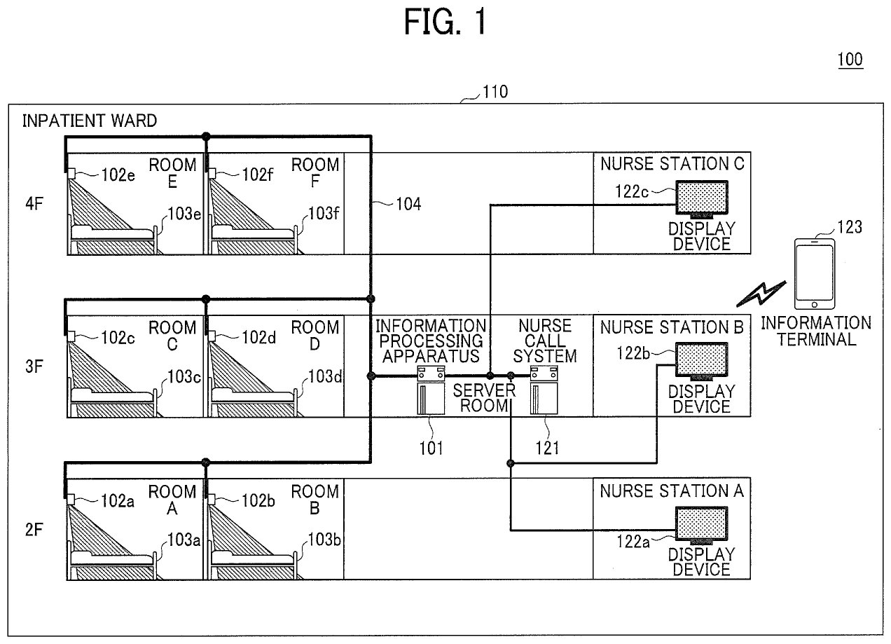

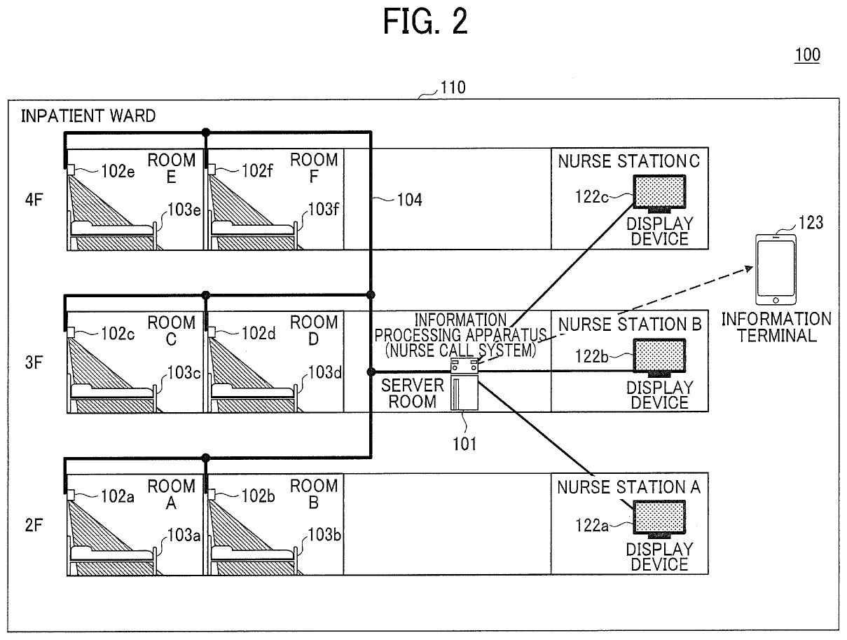

FIG. 1 is an illustration of an example of a system configuration of the information processing system 100 according to one of the embodiments. FIG. 2 is an illustration of another example of a system configuration of the information processing system 100 according to one of the embodiments. The information processing system 100 includes, for example, a plurality of cameras 102a to 102f and an information processing apparatus 101. The plurality of cameras 102a to 102f is installed in an inpatient ward 110, which is an example of a facility such as a medical facility or a nursing facility. The plurality of cameras 102a to 102f is connected to the information processing apparatus 101 via a network 104.

In the following description, “camera 102” or “cameras 102” is used to indicate any one or ones of a plurality of cameras 102a to 102. The number of cameras 102 illustrated in

FIG. 1 is one example, and the number of cameras 102 may be another number equal to or greater than one.

The camera 102 is an image capturing device that captures image data indicating temperature of an object (temperature image data). For example, a general infrared thermographic camera (hereinafter referred to as a thermal camera) or the like may be applied. A thermal camera is a device that images infrared radiation from an object to be measured, converts the imaged infrared radiation into temperature, and visualizes the temperature distribution by color, for example. The thermal camera may be referred to as a thermography, a thermo vision, a thermo viewer, a thermo camera, or the like.

In the example of FIG. 1, each of the plurality of cameras 102a to 102f is installed on, for example, the wall or the ceiling of corresponding one of a plurality of hospital rooms A to F. Each of the plurality of hospital rooms A to F is equipped with corresponding one of a plurality of beds 103a to 103f. Namely, the cameras 102a to 102f corresponds to the beds 103a to 103f, respectively. For example, the camera 102a corresponding to the bed 103a is installed on a wall surface in the hospital room A so as to be capable of capturing image data indicating temperature of the bed 103a and temperature of an area around the bed 103a.

Further, the camera 102a captures the image data indicating the temperature of the bed 103a and the temperature of the area around the bed 103a at a predetermined frame rate (for example, approximately 5 fps to 1 fps), and transmits the captured (acquired) image data to the information processing apparatus 101 via the network 104. However, the image data captured by the camera 102a is not limited to video data (moving image data), and may be, for example, still image data captured at predetermined time intervals (for example, 1 second to 60 second intervals).

At this time, the image data transmitted from the camera 102a includes identification information (ID), such as for example, an internet protocol (IP) address, a camera ID, or a bed ID, for identifying the camera 102a, the bed 103a, or the like.

Similarly, each of the other cameras 102b to 102f captures image data indicating the temperature of the corresponding bed and the temperature of the area around the corresponding bed, and transmits the captured image data together with the corresponding identification information to the information processing apparatus 101 via the network 104.

The information processing apparatus 101 is, for example, a single information processing device that has a computer configuration or a system that includes a plurality of information processing devices each of which has the computer configuration. The information processing apparatus 101 acquires the image data (temperature image data) transmitted from the camera 102, and uses the acquired image data to detect a temperature in one or more detection areas set in a range including an area around the bed 103 and the bed 103. In addition, the information processing apparatus 101 provides information indicating a state (condition, situation) of the user who uses the bed 103 to a predetermined notification destination, such as for example, a nurse call system 121, based on the temperature detected in one or more detection areas. In the following description, the information indicating a state of a user is referred to as user information. A detailed description of a process of transmitting a notification of the user information to the predetermined notification destination from the information processing apparatus 101 is given later.

The user may include, for example, a patient who is hospitalized in a medical facility, a resident who is resident in a nursing facility, and the like. In the description of the present embodiment, as an example, the user is a patient admitted to the inpatient ward 110.

The nurse call system 121 is, for example, a single information processing device that has a computer configuration or a system that includes a plurality of information processing devices each of which has the computer configuration. The nurse call system 121 is an example of the predetermined notification destination to which the information processing apparatus 101 transmits the notification of the user information. Namely, the nurse call system 121 is a communication device. The nurse call system 121 causes display devices 122a to 122c or an information terminal 123 to display information on a call made by the user who uses the bed 103. The display devices 122a to 122c are installed in nurse stations A to C, respectively. The information terminal 123 is possessed by a staff of the facility. Examples of the staff include a nurse, a caregiver, and a care person.

As illustrated in FIG. 1, the nurse call system 121 according to the present embodiment is connected to the information processing apparatus 101 via the network 104 and receives the user information notified from the information processing apparatus 101. In addition, the nurse call system 121 causes the display devices 122a to 122c, the information terminal 123, or the like to display a display screen for notifying a state of the user based on the received user information.

Each of the plurality of display devices 122a to 122c is a display device installed in, for example, a nurse station or the like, and displays a display screen transmitted from the nurse call system 121 or the information processing apparatus 101.

The information terminal 123 is, for example, an information processing device such as a smartphone, a tablet terminal, or a notebook personal computer (PC) possessed by the staff such as a nurse or a caregiver. The information terminal 123 is communicably connected to the nurse call system 121 by, for example, wireless communication, and capable of displaying the display screen, which is transmitted from the nurse call system 121 or the information processing apparatus 101, by executing a predetermined application program (hereinafter referred to as an application).

The function of the nurse call system 121 may be included in the information processing apparatus 101, for example, as illustrated in FIG. 2. Alternatively, the function of the information processing apparatus 101 may be implemented by the nurse call system 121.

Each of the display devices 122a to 122c and the information terminal 123 is another example of the predetermined notification destination to which the information processing apparatus 101 notifies the user information. Namely, each of the display devices 122a to 122c and the information terminal 123 is a communication device.

Example of Arrangement of Beds and Cameras

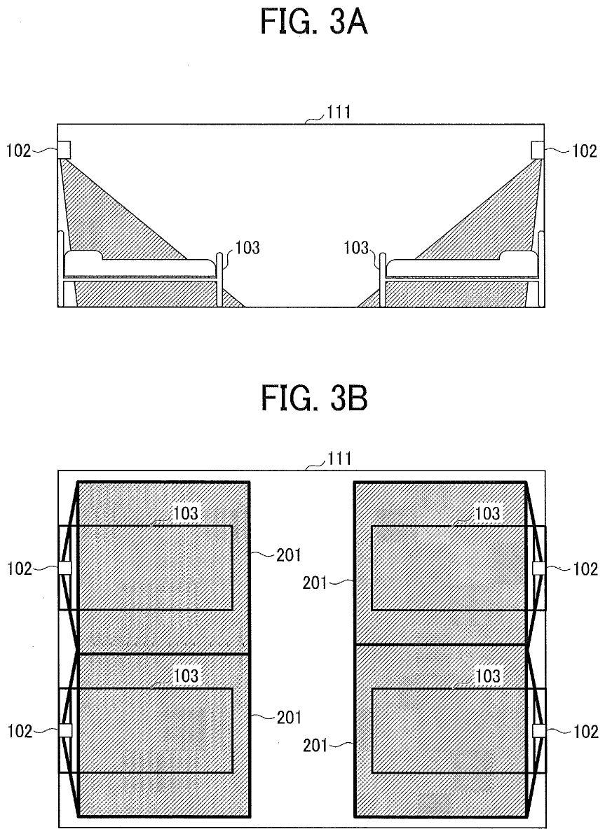

FIG. 3A and FIG. 3B are diagrams each illustrating an example of an arrangement of the beds and the cameras, according to one or more embodiments. As illustrated in FIG. 3A, the camera 102 is installed on the wall surface of the hospital room 111 so as to acquire the image data of the bed 103, which is corresponding to the camera 102, and an area around the bed 103. The camera 102 may be installed on the ceiling of the hospital room 111.

FIG. 3B illustrates a state in which the hospital room 111 is viewed from the above. The camera 102 is installed so as to acquire image data of a predetermined range (hereinafter, referred to as a detection range 201) including the bed 103 corresponding to the camera 102 and an area around the bed 103.

Example of Detection Area

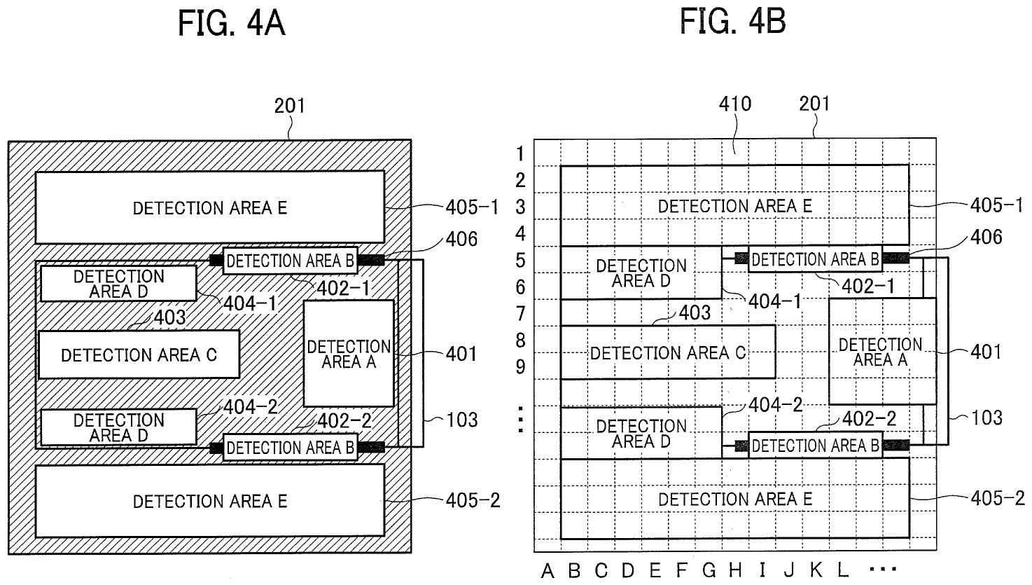

FIG. 4A and FIG. 4B are diagrams each illustrating an example of detection areas according to the present embodiment. The information processing apparatus 101 manages area information that is information on one or more detection areas set in advance within the detection range 201 of the camera 102. As illustrated in FIG. 4A, a plurality of detection areas is set within the detection range 201 of the camera 102, for example. In the example of FIG. 4A, a detection area A 401, detection areas B 402-1 and 402-2, a detection area C 403, detection areas D 404-1 and 404-2, and detection areas E 405-1 and 405-2 are set as the plurality of detection areas in the detection range 201.

In the following description, “detection area B 402” is used to indicate any one of the detection areas B 402-1 and 402-2. In addition, “detection area D 404” is used to indicate any one of the detection areas D 404-1 and 404-2, in the following description. In addition, “detection area E 405” is used to indicate any one of the detection areas E 405-1 and 405-2, in the following description.

In the example of FIG. 4A, the detection area A 401 is set to include an area in which the pillow used by the user is placed. In addition, the bed 103 is equipped with, for example, bed rail sides 406 for preventing the user from being fall down from the bed 103, and the detection areas B 402-1 and 402-2 are set so as to include a part or all of the corresponding bed rail side 406. In addition, the detection area C 403 is set in the center of the bed 103, and detection areas D 404-1 and 404-2 are set at an end of the bed 103 where there is no bed rail side 406. In addition, the detection areas E 405-1 and 405-2 are set in areas (corresponding to a part of floor, etc.) adjacent to the sides of the bed 103.

The information processing apparatus 101 manages a plurality of positions corresponding to the plurality of detection areas based on, for example, coordinate information of the image data. As another example, the information processing apparatus 101 divides the image data into sub-areas (mesh) as illustrated in FIG. 4B, and manages the plurality of positions of the plurality of detection areas based on the divided sub-areas. In the above-described example case, the information processing apparatus 101 manages the plurality of positions of the plurality of detection areas by combining information indicating positions of the divided sub-areas in a vertical direction (1, 2, 3, . . . ) and information indicating positions of the divided sub-areas in a horizontal direction (A, B, C, . . . ). For example, in FIG. 4B, the positions of the detection areas D 404-1 are represented by “B5, C5, D5, E5, F5, G5, B6, C6, D6, E6, F6, G6”.

Determination Condition and Determination Result

The information processing apparatus 101 that detects a predetermined temperature in the plurality of detection areas using the image data acquired from the camera 102 determines a state of the user based on information one or more detection areas from each of which the predetermined temperature is detected or information indicating changes in the one or more detection areas.

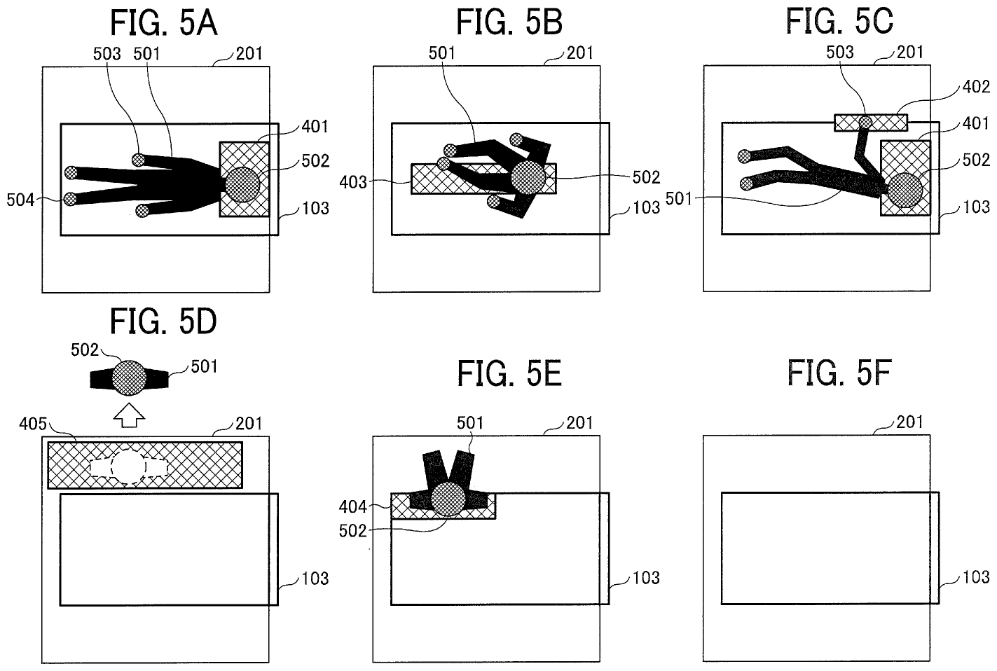

FIG. 5A to FIG. 5F are illustrations each for explaining a determination condition and an example of a determination result according to the present embodiment. FIG. 5A depicts an image including a temperature image of a user 501 who lying down on the bed 103. In the example of FIG. 5A, the user 501 wears clothes such as pajamas or loungewear, so that a head 502, hands 503, feet 504, etc. are displayed in color of a temperature range corresponding to a body temperature of the user 501.

As described above, when the predetermined temperature (for example, a temperature within 35 degrees to 39 degrees) corresponding to the body temperature of the user 501 is detected in the detection area A 401, the information processing apparatus 101 may determine the state of the user 501 as “sleeping”. The state of “sleeping” is a state in which the user 501 is lying on the bed. This is because a case where the feet 504 or the hands 503 of the user 501 are at a position of the pillow of the user 501 is generally considered as a rare case.

This method allows the information processing apparatus 101 to determine the state of the user 501 as “sleeping” even in a case where the temperatures of the hands 503 and the feet 504 of the user 501 are not detectable because the user 501 is covered with a futon, a blanket, or the like, for example. In the present embodiment, “sleeping” includes a state in which the user 501 is awake and lying on the bed 103.

FIG. 5B depicts a temperature image of the user 501 when the user 501, who is in a relatively good physical condition, gets up from the “sleeping” state. As described above, when the predetermined temperature corresponding to the body temperature of the user 501 is not detected in the detection area A 401 and the predetermined temperature is detected in the detection area C 403, the information processing apparatus 101 may determine the state of the user 501 as “getting up”. The state of “getting up” is a state in which the user 501 is getting up or sitting up on the bed, for example.

However, some of the users 501 may have difficulty to get up by themselves and do not want to get up by themselves (for example, patients who have just awakened from anesthesia after surgery). In such a case, a “sign of getting up” is desired to be detected before the user 501 is in the state of “getting up”, and the notification is desired to be transmitted to the predetermined notification destination as early as possible. In the description of the present embodiment, the “sign of getting up” means an action taken by the user before the user gets up, namely “sign of getting up” is replaceable with a “precursor to getting up”.

For example, movement patterns of the user 501, which may be uniquely seen before the user 501 is to get up, are specified. Then, when one or more of the movement patterns of the user 501 are actually detected among the movement being recorded, the notification indicating the “sign of getting up” may be transmitted to the predetermined notification destination.

As a specific example, when the user 501 gets up, depending on his or her physical condition, he or she may hold the bed rail side 406 positioned at a side of the bed 103 and gets up by himself or herself with the assistance of the bed rail side 406. In this case, the user 501 holds the bed rail side 406 from the state of being lying on the bed 103, so that temperature corresponding to the body temperature of the user 501 is detected in each of the detection area A 401 and the detection area B 402, as illustrated in FIG. SC, for example. Accordingly, for example, when detecting the temperatures, each of which corresponds to the body temperature of the user 501, in the detection area A 401 and the detection area B 402 at the same time, the information processing apparatus 101 may determine that the user 501 is in a state of indicating a “sign of getting up”.

The information processing apparatus 101 determines that the user 501 is in the state of indicating the “sign of getting up” when the state illustrated in FIG. 5C is detected from the state of “sleeping” illustrated in FIG. 5A. This prevents the information processing apparatus 101 from erroneously detecting the state of indicating the “sign of getting up” and notifying this to the predetermined notification destination in a case where the user 501 grabs the bed rail side 406 and then lie down on the bed 103, for example.

FIG. 5D depicts a temperature image of the user 501 when a state of “getting out of bed” indicating that the user 501 leaves the bed 103 is detected. For example, when the predetermined temperature corresponding to the user 501 that has been detected in the detection area E 405 is no longer detected within the detection range 201, the information processing apparatus 101 may determine the state of the user 501 as “getting out of bed”. The state of “getting out of bed” is a state in which the user 501 leaves the bed 103.

FIG. 5E depicts a temperature image of the user 501 when a state of “sitting on edge of bed” indicating that the user 501 sits on the edge of the bed is detected. For example, as illustrated in FIG. 5E, when the predetermined temperature corresponding to the user 501 is continuously detected in the detection area E 404 for a predetermined time or more, the information processing apparatus 101 may determine the state of the user 501 as “sitting on edge of bed”. The state of “sitting on edge of bed” is a state in which the user 501 sits on the edge of the bed 103.

FIG. 5D depicts a temperature image of the user 501 when a state of being “absent” indicating that the user 501 is not within the detection range 201 is detected. As illustrated in FIG. 5F, when the predetermined temperature corresponding to the user 501 is not detected for the predetermined time or more in any detection areas, the information processing apparatus 101 may determine the state of the user 501 as being “absent”. The state of being “absent” is a state in which the user 501 is neither on the bed 103 nor around the bed 103.

The information processing apparatus 101 may determine the state related to the user 501 by combining two or more states among the states illustrated in FIG. 5A to FIG. 5F. For example, when the state of the user 501 changes from the state of “getting up” as illustrated in FIG. 5B to the state of “sitting on edge of bed” as illustrated in FIG. 5E, the information processing apparatus 101 may determine the state of the user 501 as indicating a “sign of getting out of bed”. In the description of the present embodiment, the “sign of getting out of bed” means an action taken by user before the user gets out of bed, namely it can be said as or it is replaceable with a “precursor to getting out of bed”.

Information Processing System

A description is given below of the information processing system 100 according to the present embodiment. In the information processing system 100 described with reference to FIGS. 1 to 5, the user information indicating the state of the user 501 is desired to be notified to the predetermined notification destination according to an activity pattern of each user 501.

For example, when the user 501 is a patient hospitalized in a medical facility, the user 501 may get up from the bed during the day and do various activities such as watching a television (TV), reading a book, and eating. In a case where the information processing system detects that the user gets up during the day and notifies the predetermined notification destination of the user information indicating that the user 501 is in the “getting up” state, a notification of the user information is unnecessary, resulting in increasing unnecessary notifications.

On the other hand, when a state of the user 501 of getting up at night or of indicating a sign of getting up is detected, the user 501 may take an action that requires caution, such as going to a bathroom or wandering around. Accordingly, such a detection result is desired to be notified to the predetermined notification destination, depending on the user 501.

In addition, some of the users 501 have difficulty to get up by themselves and do not want to get up by themselves (for example, patients who have just awakened from anesthesia after surgery). Due to this reason, even during the daytime, depending on the user 501, there is a case where the user information is desired to be notified to the predetermined notification destination indicating that the user is in the state of “getting up” or indicating a “sign of getting up”.

However, in the conventional technique, an information processing system, which notifies a predetermined notification destination of a state of the user 501 by using image data of the user 501, has difficulty to determine whether to transmit the user information to the notification destination according to an activity pattern for each user 501.

The information processing apparatus 101 according to the present embodiment manages setting information that includes information on one or more “time zones”, one or more “determination results”, and “notification details”. An information item of “time zone” is set for detecting the state of the user 501, and an information item of “determination result” corresponds to the information item of “time zone”. An information item of “notification details” is determined according to a combination of one of the one or more “time zones” and one of the one or more “determination results”. In the setting information, the information item of “time zone”, the information item of “determination result”, and the information item of “notification details” are associated with each other for each bed 103.

The information item of “time zone” is time information. According to the time information, the information item of the determination result or the information item of the notification details may change. The time zones may be set such as daytime and nighttime, or morning, afternoon, and night, for example. For example, when the determination condition for detecting the state of the user 501 is desired to change between daytime and nighttime, a time zone of daytime (for example, 7:00 to 21:00) may be set as a time zone A, and a time zone of nighttime (for example, 21:00 to 7:00) may be set as a time zone B. However, the disclosure is not limited to this, and in one or more embodiments, the “time zones” may include, for example, three or more time zones such as morning, afternoon, and night, or may be a single time zone.

The “determination result” is information for setting the state of the user 501 to be detected in each time zone. For example, when the states of “getting out of bed” and “absent” described above with reference to FIG. 5D are desired to be detected during a time zone of daytime, each of “getting out of bed” and “absent” are set as “determination result” in the time zone of daytime. Similarly, the states of “getting up” and “sign of getting up” described above with reference to FIG. 5B and FIG. 5C are desired to be detected during a time zone of nighttime, “getting up” and “sing to get up” are set as “determination result” in the time zone of nighttime. However, the present disclosure is not limited to this, and in one or more embodiments, a determination condition for determining the state of the user 501 may be set in the “determination result”. For example, when the state of “sleeping” described above with reference to FIG. 5A is desired to be detected, the “determination result” includes conditions for detecting the state of the user 501 as “sleeping” (for example, a predetermined temperature of the user 501 is detected in the detection area A 401).

The “notification details” is information for setting what kind of notification is to be given to the predetermined notification destination when the “determination result” set in each “time zone” is detected. For example, in a case where information indicating “warning” is desired to be informed to the predetermined notification destination when the determination result of “absent” is detected during the daytime, a notification level “warning” is set in the “notification details” corresponding to a combination of the time zone of “daytime” and the determination result of “absent”. Similarly, in a case where information indicating “caution” is desired to be informed to the predetermined notification destination when the determination result of “sign of getting up” is detected in the time zone of nighttime, a notification level “caution” is set in the “notification details” corresponding to a combination of the time zone of “nighttime” and the determination result of “sign of getting up”. However, the present disclosure is not limited to this, and in one or more embodiments, a predetermined notification destination may be set in information on the “notification details”, for example.

Since the information processing apparatus 101 manages the setting information as described above for each bed 103 (for each user 501), the information processing apparatus 101 is capable of determining whether to notify the predetermined notification destination of the state, based on the image data of the user 501 and the setting information.

Further, according to the present embodiment, the setting information that is settable for each bed 103 (user 501) facilitates to notify the notification destination of necessary information according to the activity pattern of each user 501.

The bed 103 may be another one of various types of facilities (a piece of equipment) on which the user is able to lie down in substantially the same manner as the user lies down on the bed. An example of such a facility (a piece of equipment) may be a stretcher, an operating table, or an examination table in a facility such as a medical facility or a nursing facility.

Hardware Configuration

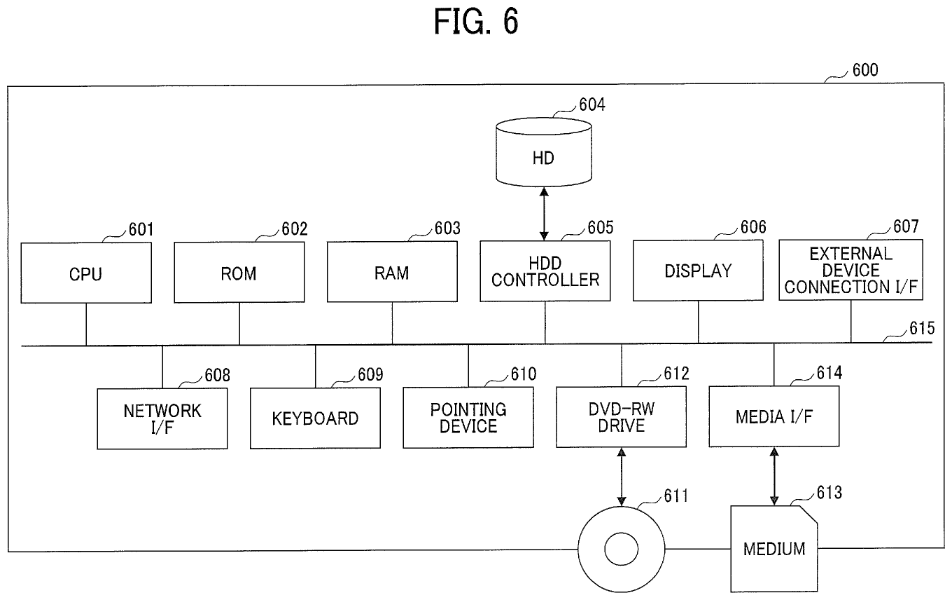

A description is given below of a hardware configuration of the information processing apparatus 101. The information processing apparatus 101 includes, for example, a hardware configuration of a computer 600 as illustrated in FIG. 6. Alternatively, the information processing apparatus 101 includes a plurality of computers each of which is corresponding to the computer 600.

FIG. 6 is a block diagram illustrating the hardware configuration of the computer 600 according to the present embodiment of the disclosure. The computer 600 includes, but not limited to, a central processing unit (CPU) 601, a read only memory (ROM) 602, a random access memory (RAM) 603, a hard disk (HD) 604, a hard disk drive (HDD) controller 605, a display 606, an external device connection interface (I/F) 607, a network I/F 608, a keyboard 609, a pointing device 610, a digital versatile disk-rewritable (DVD-RW) drive 612, a media I/F 614, a bus line 615.

Among these elements, under the control of the CPU 601, the computer 600 operates. The ROM 602 stores a program used for driving the computer 600, such as an initial program loader (IPL). The RAM 603 is used, for example, as a work area of the CPU 601 or the like. The HD 604 stores various data such as a control program. The HDD controller 605 reads and writes various data from and to the HD 604 under control of the CPU 601.

The display 606 displays various information such as a cursor, a menu, a window, a character, or an image. The external device connection I/F 607 is an interface for connecting various external devices. The network I/F 608 is an interface for performing data communication using the network 104.

The keyboard 609 is one example of an input device provided with a plurality of keys for allowing a user to input characters, numerals, or various instructions. The pointing device 610 is an example of an input device that allows a user to select or execute a specific instruction, select a target for processing, or move a cursor being displayed. The DVD-RW drive 612 controls reading or writing of various data from or to a DVD-RW 611, which is an example of a removable recording medium. The DVD-RW 611 is not limited to the DVD-RW 611, and may be another recording medium. The media I/F 614 controls reading or writing (storage) of data to a medium 613 such as a flash memory or a memory card. The bus line 615 includes an address bus, a data bus, various control signals, and the like for electrically connecting each of the above components.

Functional Configuration

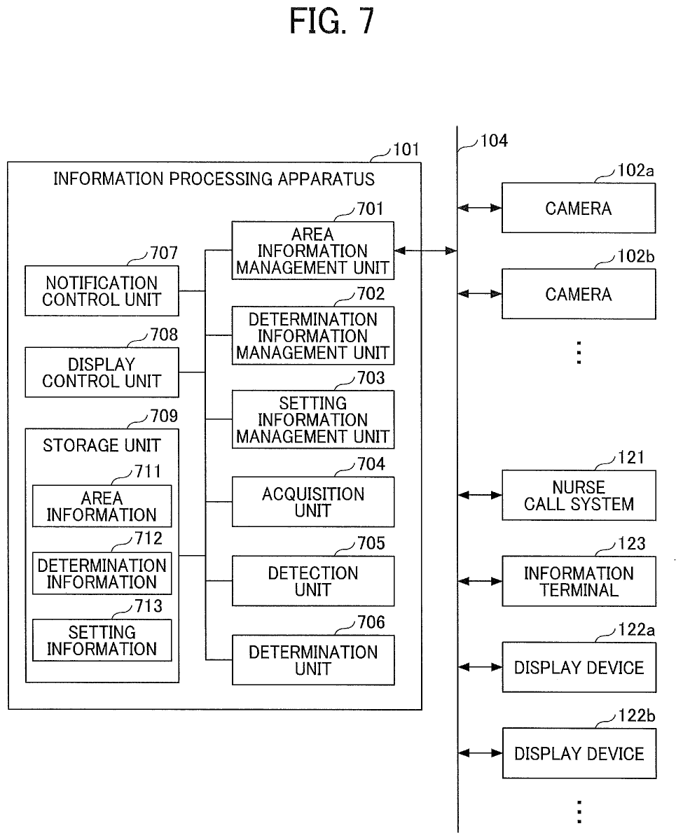

A description is given below of a functional configuration of the information processing system 100. FIG. 7 is a diagram illustrating an example of a functional configuration of the information processing system 100 according to the present embodiment. The information processing system 100 includes, for example, the information processing apparatus 101 that is connected to the network 104 such as a local area network (LAN), and a plurality of cameras including the camera 102a, the camera 102b, and the like. Further, the information processing apparatus 101 communicably connected to a predetermined notification destination via the network 104. Examples of the predetermined notification destination includes the nurse call system 121, the information terminal 123, and a plurality of display devices including the display device 122a, the display device 122b, and the like.

Functional Configuration of Information Processing Apparatus

The information processing apparatus 101 includes an area information management unit 701, a determination information management unit 702, a setting information management unit 703, an acquisition unit 704, a detection unit 705, a determination unit 706, a notification control unit 707, a display control unit 708, and a storage unit 709. These functional units are implemented by executing a predetermined program on the CPU 601 illustrated in FIG. 6, for example. Alternatively, the information processing apparatus 101 may implement each of the above functional units by executing a predetermined program on a plurality of computers 600. Note that at least a part of the above functional units may be implemented by hardware.

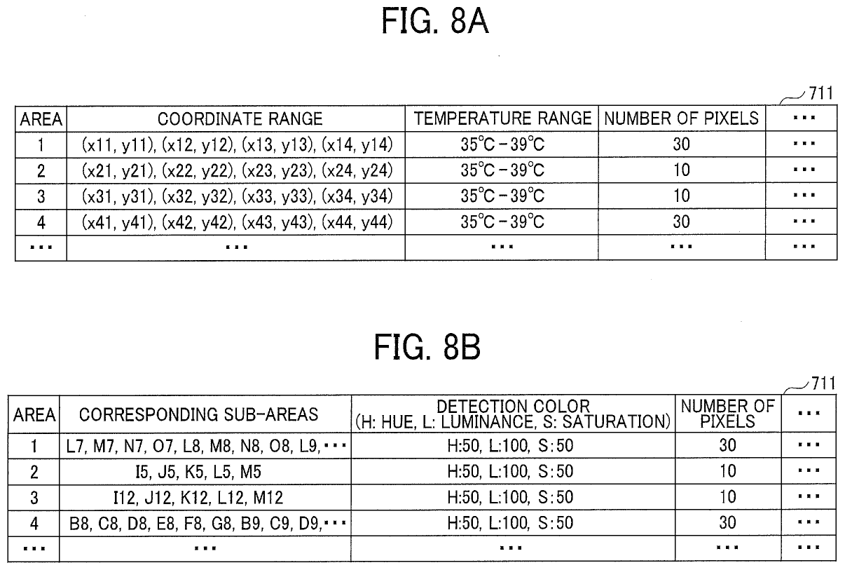

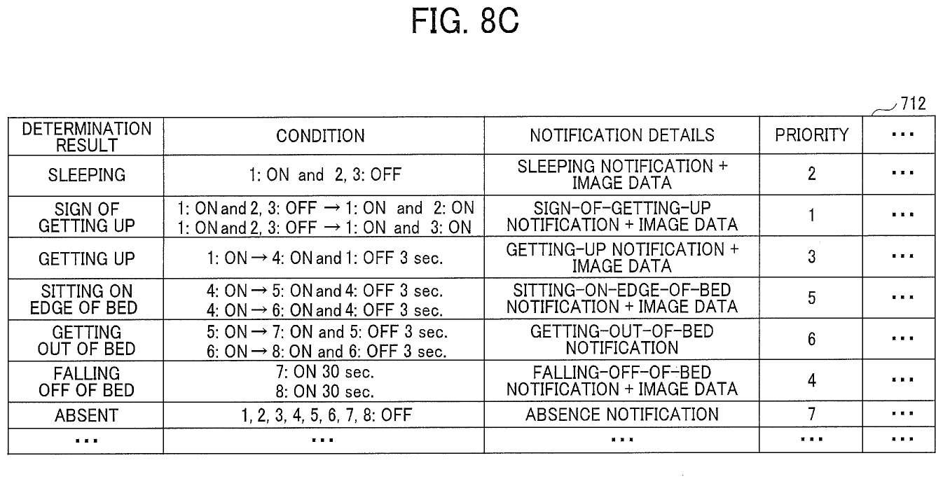

The area information management unit 701 stores, in the storage unit 709, area information 711 and manages the area information 711 in which a plurality of detection areas as illustrated in FIG. 4A or FIG. 4B or the like is managed. FIG. 8A is a diagram illustrating an example of a table corresponding to the area information 711 that is for managing the plurality of detection areas as illustrated in FIG. 4A, according to the present embodiment. In the example of FIG. 8A, the area information 711 includes information items of “area”, “coordinate range”, “temperature range”, and “number of pixels”.

The information item of “area” is information indicating a number or a name (for example, detection area A, etc.) that identifies a detection area. The information item of “coordinate range” is an example of information indicating a range of a detection area. For example, when a detection area is rectangular, the coordinate range is represented by coordinates indicating four vertices of the detection area. Information on the range of each detection area may be represented by, for example, a combination of columns and rows of a plurality of sub-areas corresponding to the corresponding detection area, as illustrated in FIG. 8B.

The “temperature range” is an example of information indicating a rage of a predetermined temperature (predetermined temperature range) to be detected. The information indicating the predetemined temperature range may be represented by a detection color of the image data (temperature image data), for example, as illustrated in FIG. 8B. The “number of pixel” is an example of information indicating a size of an area targeted for the detection of a predetermined temperature, which is within the predetermined temperature range. For example, the detection area identified by an area “1” in FIG. 8A is a color area corresponding to the temperature range of “35 degrees to 39 degrees” within the coordinate range of the area “1”. When there is an area having a size corresponding to the number of pixels of “30” or more, it is determined that the predetermined temperature is detected in the area “1”. For example, the detection area identified by an area “2” in FIG. 8A is a color area corresponding to the temperature range of “35 degrees to 39 degrees” within the coordinate range of the area “2”. When there is an area having a size corresponding to the number of pixels of “10” or more, it is determined that the predetermined temperature is detected in the area “2”. The same applies to the other areas, an area “3”, an area “4”, and the like.

FIG. 8B is a diagram illustrating an example of a table corresponding to the area information 711 that is for managing the plurality of detection areas as illustrated in FIG. 4B, according to the present embodiment. In the example of FIG. 8B, the area information 711 includes information items of “area”, “corresponding sub-areas”, “detection color”, and “number of pixels”.

The information item of “area” is information indicating a number or a name that identifies a detection area, which is substantially the same as the item of “area” in the example of FIG. 8A. The information item of “corresponding sub-areas” is another example of the information indicating a range of each detection area, and used to manage each one of the plurality of detection areas by combining information indicating positions in the vertical direction (1, 2, 3, . . . ) and information indicating positions in the indicating the vertical position in the horizontal direction (A, B, C, . . . ) in the plurality of sub-areas 410 as illustrated in FIG. 4B, for example.

The information item of “detection color” is another example of information indicating the predetermined temperature range to be detected. In the example of FIG. 8B, the detection color is represented by a color space of hue (H), brightness (L), and saturation (S). The color space is not limited to hue (H), brightness (L), and saturation (S), and is, for example, red (R), green (G), blue (B), luminance (Y), color difference from blue (U), and color difference from red (V). The information item of “number of pixel” is an example of information indicating a size of an area targeted for the detection of a predetermined temperature, which is substantially the same as the item of “area” in the example of FIG. 8A.

The determination information management unit 702 stores, for example, determination information 712 as illustrated in FIG. 8C in the storage unit 709 or the like and manages the determination information 712. FIG. 8C an example of a table corresponding to the determination information 712 managed by the determination information management unit 702. In the example of FIG. 8C, the determination information 712 includes information items of “determination result”, “deteimination condition”, “notification details”, and “priority”.

The information item of “determination result” is, for example, information indicating a determination result when a detection result of a predetermined temperature in the plurality of detection areas as illustrated in FIG. 4A or FIG. 4B satisfies “determination condition”. The information item of “determination condition” is information indicating a determination condition for each “determination result”. The information item of “notification details” is information indicating notification details to be notified to a predetermined notification destination when a detection result obtained by the detection unit 705 satisfies a corresponding “determination condition”. The information item of “priority” is information indicating a priority among a plurality of “determination results”.

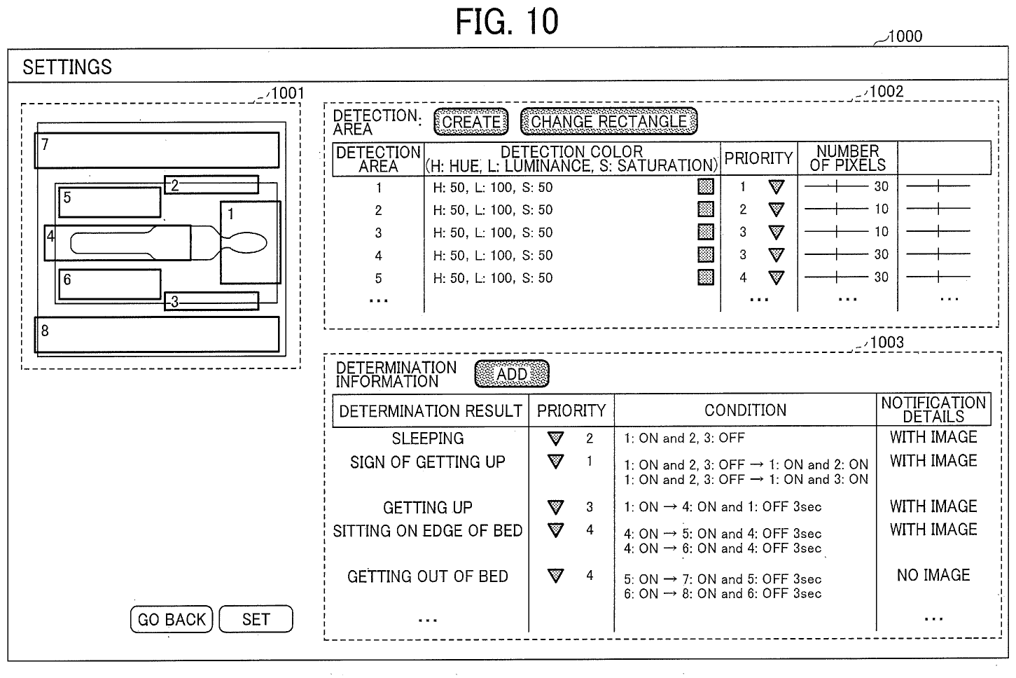

An administrator or the like who manages the information processing apparatus 101 may cause the information processing apparatus 101 to display, for example, a setting screen 1000 as illustrated in FIG. 10 to set the area information 711, the determination information 712, and the like.

FIG. 10 is a diagram illustrating an example of a setting screen (screen for settings) 1000 according to the present embodiment. In the example of FIG. 10, the setting screen 1000 includes, for example, a display section 1001 that is for displaying the plurality of detection areas, a detection area setting section 1002, and a determination information setting section 1003.

In the display section 1001, as an example, detection areas 1 to 8 corresponding to the detection area A 401, the detection areas B 402-1, 402-2, the detection area C 403, the detection areas D 404-1, 404-2, and the detection areas E 405-1 and 405-2 as illustrated in FIG. 4A are displayed. For example, the detection area 1 corresponds to the detection area A 401 illustrated in FIG. 4A, and the detection areas 2 and 3 correspond to the detection areas B 402-1 and 402-2 illustrated in FIG. 4A. Further, the detection area 4 corresponds to the detection area C 403 illustrated in FIG. 4A, and the detection areas 5 and 6 correspond to the detection areas D 404-1 and 404-2 illustrated in FIG. 4A. Further, the detection areas 7 and 8 correspond to the detection areas E 405-1 and 405-2 illustrated in FIG. 4A.

For example, the administrator or the like may change a position, a size, etc. of each detection area in the display section 1001 by performing a user operation (predetermined operation) such as a drag operation, a pinch-in operation, or a pinch-out operation.

In the detection area setting section 1002, another detection area is newly addable and the information items of “detection color”, “priority”, “number of pixels” and the like for each detection area are settable. Further, the area information management unit 701 stores and manages the information set in the detection area setting section 1002 in the area information 711 as illustrated in FIG. 8A or FIG. 8B, for example.

In the determination information setting section 1003, a determination result is addable, and the information items of “priority”, “determination condition”, “notification details” and the like for each determination result are settable. In the information item of “determination condition”, “1: ON” indicates a state in which the predetermined temperature is detected in the detection area of the area “1” (detection area A 401). Further, “1: OFF” indicates a state in which the predetermined temperature is not detected in the detection region of the area “1”. The same applies to the other areas, the area “2”, the area “3”, and the like. Further, in the “determination condition”, an arrow indicates a transition of the state.

For example, in the determination information setting section 1003 of FIG. 10, the determination condition for the determination result of “sleeping” is that the predetermined temperature is detected in the detection area of the area “1” (detection area A 401) but not detected in the detection areas of “2” and “3” (detection area B 402).

Further, the determination condition for the determination result of “sign of getting up” is a state in which the predetermined temperature is detected in the detection area of the area “1”, and a transition from a state where the predetermined temperature is not detected in the detection areas of the areas “2” and “3” (the state of sleeping) to the state where the predetermined temperature is detected in the detection areas of “1” and “2” (or “3”) is detected.

The determination information management unit 702 stores and manages the information set in the determination information setting section 1003 in the determination information 712 as illustrated in FIG. 8C.

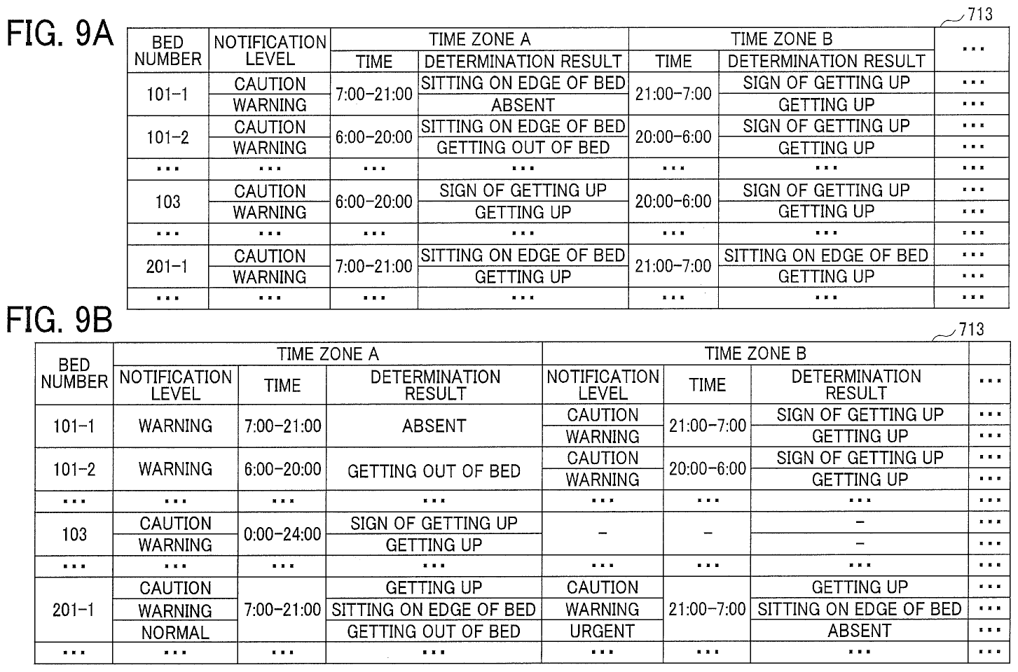

The setting information management unit 703 stores, for example, setting information 713 as illustrated in FIG. 9A in the storage unit 709 or the like and manages the setting information 713. FIG. 9A is a diagram illustrating an example of a table corresponding to the setting information 713 managed by the setting information management unit 703. In the example of FIG. 9A, the setting information 713 includes information items of “bed number”, “notification level”, “time zone A” and “time zone B”. In addition, information items such as “time” and “determination result” are set under each information item of “time zone A” or “time zone B”.

The information item of “bed number” is information indicating such as a number, a name, and identification information for identifying each bed 103. The information items of “time zone A” and “time zone B” are an example of the one or more time zones for detecting the state of the user. For example, a start time and an end time of the “time zone A” are set in the information item of “time” under the information item of “time zone A”. Similarly, a start time and an end time of the “time zone B” are set in the information item of “time” under the information item of “time zone B”. A value set as the “time” under each time zone may differ for each bed 103.

Further, the information item of “determination result” under the information item of “time zone A” is settable with one or more of the states of the user (determination result), “sleeping”, “getting up”, “sign of getting up”, “getting out of bed”, “sitting on edge of bed”, and “absent”, which are described with reference to FIG. 5, to be detected in the “time zone A”, for example. Similarly, in the information item of “determination result” under the information item of “time zone B”, one or more states of the user, which are to be detected in the “time zone B”, are set.

The information item of “notification level” is an example of information on the notification details according to the time zone and the “determination result”. In the example of FIG. 9A, information on levels for importance, urgency, or priority is set. Such a level is set as, for example, “warning”, “caution”, etc.

For example, in the setting information 713 illustrated in FIG. 9A, in a case where the determination result of “sitting on edge of bed” is detected in the time zone A (7:00 to 21:00) for a bed number of “101-1”, the information processing apparatus 101 notifies a predetermined notification destination of the information indicating “caution” that indicates that the state of “sitting on edge of bed” has been detected. Further, for example, in the setting information 713 illustrated in FIG. 9A, in a case where the determination result of “getting up” is detected in the time zone B (21:00 to 7:00) for the bed number of “101-1”, the information processing apparatus 101 notifies a predetermined notification destination of the information indicating “warning” that indicates that the state of “getting up” has been detected.

As described above, in the setting information 713, the information on one of the one or more time zones, the information on one or more determination results, and the information on the notification details (for example, a notification level) are associated with each other for each bed 103 used by the corresponding user 501. The information on the notification details is determined according to a combination of the information on the one of the one or more time zones and the information on the one or more determination results.

FIG. 9B is a diagram illustrating another example of a table corresponding to the setting information 713 managed by the setting information management unit 703. In the example of FIG. 9B, different information can be set for each time zone such as “time zone A” and “time zone B” as the “notification level”.

Further, the number of the time zones, such as “time zone A” and “time zone B” is not limited to two, and for example, the “time zone A” alone may be set, or three or more time zones, such as “time zone A”, “time zone B”, and “time zone C”, may be set.

Further, as the “determination result” for each time zone, for example, three or more determination results may be set as the example of a case of a bed number of “201-1” in FIG. 9B.

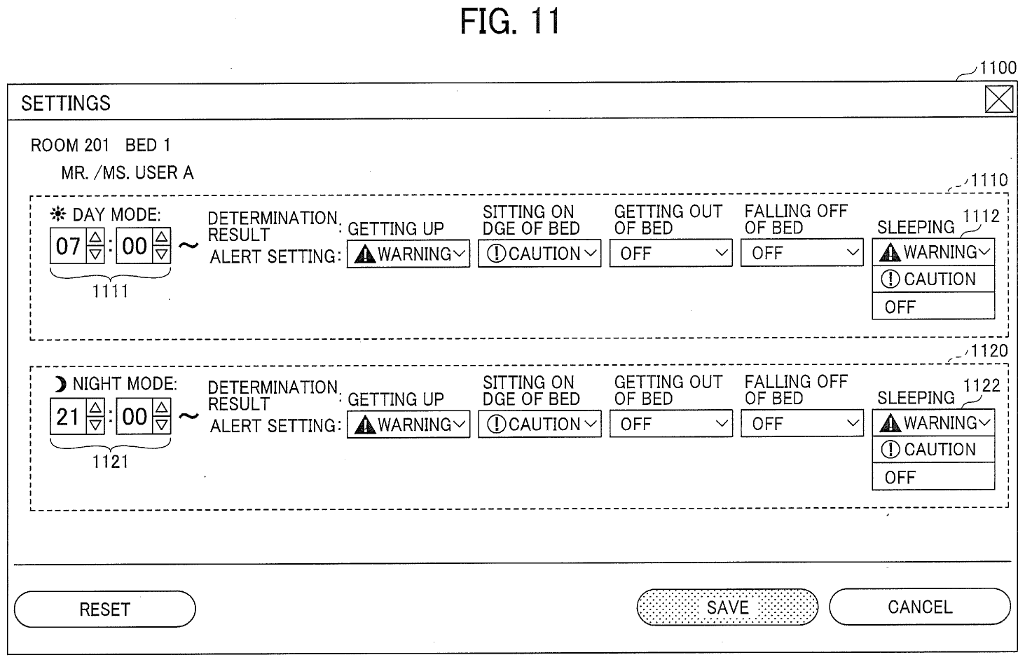

The administrator or the like who manages the information processing apparatus 101 may cause the information processing apparatus 101 to display, for example, a setting screen 1100 as illustrated in FIG. 11 to set the setting information 713.

FIG. 11 is a diagram illustrating an example of a setting screen (screen for settings) 1100 according to the present embodiment. In the example of FIG. 11, on the setting screen 1100, a first setting section 1110 for setting the determination information related to the daytime (a day mode), a second setting section 1120 for setting the determination information related to the nighttime (a night mode), and the like are displayed.

In the first setting section 1110 for setting the determination information related to the daytime, for example, a daytime-time zone setting field 1111 and a first pull-down menu 1112 for setting the notification level for each determination result in the time zone of the daytime are displayed. Similarly, in the second setting section 1120 for setting the determination information related to the nighttime, for example, a nighttime-time zone setting field 1121 and a second pull-down menu 1122 for setting the notification level for each deteitiiination result in the time zone of the nighttime are displayed.

By setting a time in the daytime-time zone setting field 1111 and the nighttime-time zone setting field 1121, the administrator or the like is able to set a “period of time” for the time zone A and a “period of time” for the time zone B for each bed 103 in the setting information 713 as illustrated in FIG. 9A, for example.

In addition, the administrator or the like uses the first pull-down menu 1112, which is used to set the notification level of each determination result in the time zone of the daytime, to set the “determination result” and the “notification level” for each bed 103 in the time zone A in the setting information 713 as illustrated in FIG. 9A.

For example, the administrator or the like selects “warning” from the first pull-down menu 1112 corresponding to the determination result of “sleeping” in the daytime-time zone setting field 1111 to add a combination (association) of the determination result of “sleeping” and the notification level of “warning” to the time zone A of the setting information 713. In addition, the administrator or the like selects “caution” from the first pull-down menu 1112 corresponding to the determination result of “sleeping” to add a combination (association) of the determination result of “sleeping” and the notification level of “caution” to the time zone A of the setting information 713.

Similarly, the administrator or the like uses the second pull-down menu 1122, which is used to set the notification level of each determination result in the time zone of the nighttime, to set the “determination result” and the “notification level” for each bed 103 in the time zone B in the setting information 713 as illustrated in FIG. 9A.

Referring back to FIG. 7, the description of the functional configuration of the information processing apparatus 101 is continued.

The acquisition unit 704 is, for example, acquires the image data transmitted via the network 104 from the camera 102 that captures the image data indicating the temperature of the bed 103 and the temperature of the area around the bed 103 (hereinafter, referred to as image data of the user 501).

The detection unit 705 detects a predetermined temperature in the plurality of detection areas by using the image data of the user 501 (temperature image data) acquired by the acquisition unit 704. For example, the detection unit 705 detects the predetermined temperature corresponding to the body temperature of the user 501 in the plurality of detection areas based on the area information 711 as illustrated in FIG. 8A or FIG. 8B stored in the storage unit 709.

The determination unit 706 determines a presence or an absence of the notification, the notification details, and the like based on the image data of the user and the setting information 713.

For example, the determination unit 706 acquires information on the settings for the user 501 corresponding to the current time zone from the setting information 713 as illustrated in FIG. 9A or FIG. 9B, based on the identification information (for example, the bed number) included in the image data of the user 501 acquired by the acquisition unit 704.

Further, the determination unit 706 determines whether the detection result of the detection unit 705 satisfies the determination condition of the “determination result” set in the setting information. For example, when the “determination result” is “sitting on edge of bed” and “absent”, the determination unit 706 acquires the determination condition corresponding to the determination result, “sitting on edge of bed” and “absent” from the determination information 712 as illustrated in FIG. 8C. Then, the determination unit 706 determines whether the predetermined temperature detected using the image data of the user 501 by the detection unit 705 satisfies the acquired determination condition or not.

When the detection result of the detection unit 705 satisfies the determination condition of the “determination result” set in the setting information, the determination unit 706 determines to transmit the notification to the predetermined notification destination. When the detection result of the detection unit 705 does not satisfy the determination condition of the “determination result” set in the setting information, the determination unit 706 determines not to transmit the notification to the predetermined notification destination.

Further, the determination unit 706 determines the notification details to be notified to the predetermined notification destination by using the acquired setting information. For example, the determination unit 706 acquires the “notification level” corresponding to the “determination result” that satisfies the determination condition from the acquired setting information, and determines the notification details according to the acquired “notification level”. For example, when the “determination result” that satisfies the determination condition is “getting up” and the “notification level” is “warning”, the determination unit 706 notifies the predetermined notification destination of information indicating “warning”, which indicate the state of the user is “getting up”.

The notification control unit 707 performs notification control for notifying the predetermined notification destination of the user information (notification) according to information on whether a presence or an absence of the notification and the notification details, which are determined by the determination unit 706. For example, when the determination unit 706 determines to transmit the notification to the predetermined notification destination, the notification control unit 707 transmits the user information including the notification details determined by the determination unit 706 to the predetermined notification destination.

The display control unit 708 displays, for example, a setting screen as illustrated in FIG. 10 or FIG. 11 on the display 606 or the like, and receives a setting operation performed by a user such as the administrator or the like. Alternatively, the display control unit 708 may function as a web server that provides a web page that displays a setting screen as illustrated in FIG. 10 or FIG. 11, to receive a setting operation performed on the setting screen.

The storage unit 709 is implemented by, for example, a program executed by the CPU 601 illustrated FIG. 6, the HD 604, the HDD controller 605, the RAM 603, or the like, and stores various data and information such as the area information 711, the determination information 712, and the setting information 713.

Note that the functional configuration of the information processing apparatus 101 illustrated in FIG. 7 is one example. The functions of the information processing apparatus 101, which are illustrated in FIG. 7, may be divided into a plurality of information processing devices, which can be placed at different locations. Further, at least a part of the functions included in the information processing apparatus 101 may be additionally or alternatively included in the nurse call system 121 or the like. Further, the storage unit 709 may be implemented by another information processing apparatus (device) (for example, a storage server) that is different from the information processing apparatus 101.

In the present embodiment, the nurse call system 121, the information terminal 123, and the display device 122 are examples of predetermined notification destinations, and may have any configurations as long as the user information notified from the information processing apparatus 101 is displayable. The redundant description thereof is omitted here.

Processes

A description is given below of a process of providing information, according to the present embodiment.

Process Performed by Information Processing Device

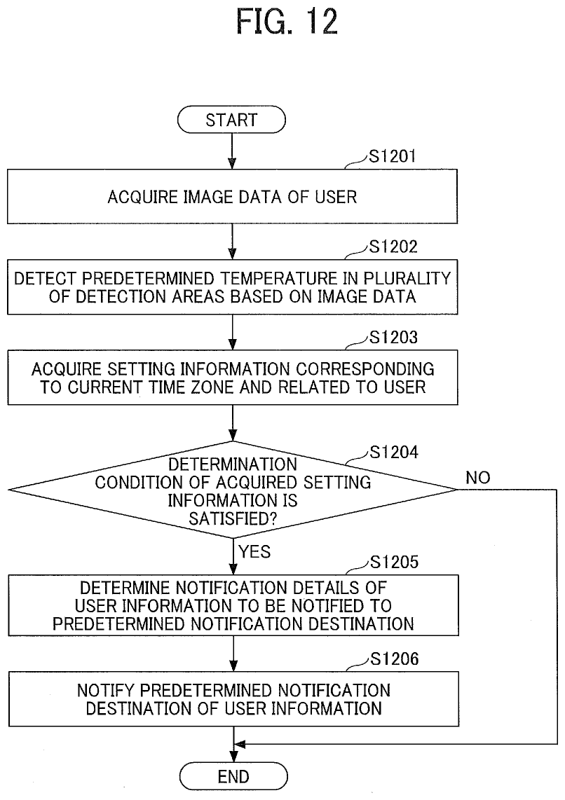

FIG. 12 is a flowchart illustrating an example of a process performed by the information processing apparatus 101 according to the present embodiment. The process is performed when the information processing apparatus 101 acquires image data (temperature image data) of the user transmitted from the camera 102.

In step S1201, the acquisition unit 704 of the information processing apparatus 101 acquires the image data of the user 501 transmitted from the camera 102, for example, at predetermined time intervals. The image data of the user 501 includes, for example, the identification information for identifying the camera 102, the bed 103, or the user 501. In the description of the present embodiment, as an example, the image data of the user 501 includes a bed number that identifies the bed 103.

In step S1202, the detection unit 705 of the information processing apparatus 101 detects the predetermined temperature in the plurality of detection areas based on the image data of the user acquired by the acquisition unit 704. For example, the detection unit 705 refers to the area information 711 as illustrated in FIG. 8A stored in the storage unit 709 to detect the predetermined temperature in each of the plurality of detection areas as illustrated in FIG. 4A. Alternatively, the detection unit 705 refers to the area information 711 as illustrated in FIG. 8B stored in the storage unit 709 to detect the predetermined temperature in each of the plurality of detection areas as illustrated in FIG. 4B.

In step S1203, the determination unit 706 of the information processing apparatus 101 acquires a piece of information (setting information), which is information on settings corresponding to a current time zone and related to the user 501 from the setting information 713 as illustrated in FIG. 9A or FIG. 9B, for example. For example, when the current time is “8:00” and the image data of the user 501 includes the bed number of “101-1”, the determination unit 706 acquires information on the determination result, which indicates “sitting on edge of bed” and “absent”, and the notification level, which indicates “caution” and “warning”, based on the setting information 713 as illustrated in FIG. 9A.

In step S1204, the determination unit 706 determines whether the predetermined temperature detected by the detection unit. 705 satisfies the determination condition of the acquired setting information. For example, when the acquired setting information includes the determination results “sitting on edge of bed” and “absent”, the determination unit 706 acquires the determination conditions corresponding to “sitting on edge of bed” and “absent” based on the determination information 712 as illustrated in FIG. 8C. In addition, the determination unit 706 determines whether the predetermined temperature detected by the detection unit 705 satisfies the acquired determination condition of “sitting on edge of bed” or “absent”.

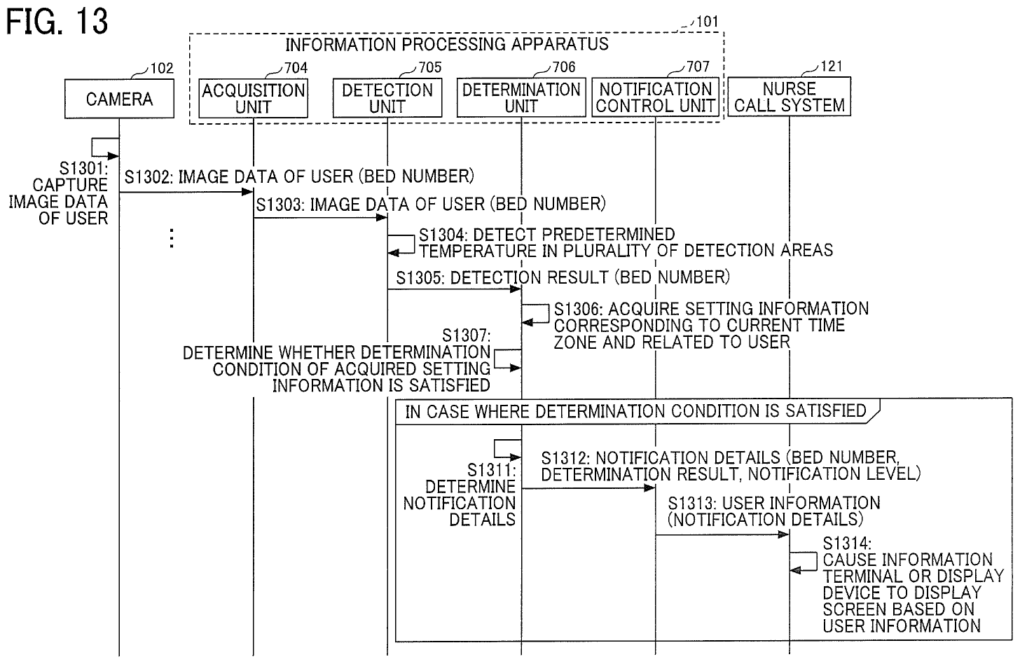

When the predetermined temperature detected by the detection unit 705 satisfies the determination condition of the acquired setting information, the process performed by the determination unit 706 proceeds to step S1205. On the other hand, when the predetermined temperature detected by the detection unit 705 does not satisfy the determination condition of the acquired setting information, the notification control unit 707 of the information processing apparatus 101 cancels notifying the predetermined notification destination of the user information, and the process of FIG. 13 ends.

When the process proceeds to step S1205, the determination unit 706 determines the notification details of the user information to be notified to the predetermined notification destination. For example, when the determination information indicating the “sitting on edge of bed” is satisfied for the bed number “101-1” and the time zone A of the setting information 713 as illustrated in FIG. 9A, the determination unit 706 determines the notification details to be notified to the predetermined notification destination as “caution” information that includes the determination result of “sitting on edge of bed”. On the other hand, when the determination information indicating “absent” is satisfied for the bed number “101-1” and the time zone A, the determination unit 706 determines the notification details to be notified to the predetermined notification destination as “warning” information that includes the determination result of “absent”.

In step S1206, the notification control unit 707 of the information processing apparatus 101 notifies the predetermined notification destination (for example, the nurse call system 121) of the user information including the notification details determined by the determination unit 706.

Process Performed by Information Processing System

A description is given below of an example of a process that is performed by the information processing system 100 and corresponding to the process of FIG. 12 performed by the information processing apparatus 101, according to the present embodiment.

### First Embodiment

FIG. 13 is a sequence diagram illustrating an example of a process performed by the information processing system 100 according to a first embodiment.

In step S1301, when the camera 102 captures the image data (image data of the user 501) of the bed 103 and the area around the bed 103, which are corresponding to the camera 102, the subsequent steps after step S1302 are performed.

In step S1302, the camera 102 transmits the image data (temperature image data) of the user 501, who is a target to be captured by the camera 102, to the information processing apparatus 101. The image data includes, for example, the identification information for identifying the camera 102, the bed 103, the user 501, or the like. In the following description of the present embodiment, as an example, the image data includes a bed number that identifies the bed 103.

The camera 102 repeatedly executes the processes of steps S1301 and S1302 at predetermined time intervals (for example, at intervals of several seconds to several tens of seconds).

In step S1303, the acquisition unit 704 of the information processing apparatus 101 notifies the detection unit 705 of the image data of the user 501 acquired from the camera 102.

The acquisition unit 704 may store the image data of the user 501 acquired from the camera 102 in the storage unit 709. Then, the acquisition unit 704 may notifies the detection unit 705 of information indicating a storage destination of the image data or information for identifying the image data, for example the bed number included in the image data.

In step S1304, the detection unit 705 of the information processing apparatus 101 detects the predetermined temperature in the plurality of detection areas based on the image data of the user 501 notified by the acquisition unit 704. This step corresponds to the step S1202 in FIG. 12.

In step S1305, the detection unit 705 notifies the determination unit 706 of a detection result of the predetermined temperature in the plurality of detection areas. As described above, the detection result includes the bed number which is an example of the identification information.

In step S1306, the determination unit 706 of the information processing apparatus 101 acquires the setting information of the user 501 corresponding to a current time zone. For example, the determination unit 706 acquires information including the bed number included in the image data of the user 501, information on the one or more “determination results” and the one or more “notification levels” corresponding to the current time and the like, based on the setting information 713 as illustrated in FIG. 9A. This step corresponds to the step S1203 in FIG. 12.

In step S1307, the determination unit 706 determines whether the predetermined temperature detected by the detection unit 705 satisfies the determination condition of the acquired setting information. This step corresponds to the step S1204 in FIG. 12.

In response to a determination indicating that the predetermined temperature detected by the detection unit 705 satisfies the determination condition of the acquired setting information, the processes of steps S1311 to S1314 are performed.

In step S1311, the determination unit 706 determines the notification details of the user information to be notified to the predetermined notification destination. This step corresponds to the step S1205 in FIG. 12.

In step S1312, the determination unit 706 notifies the notification control unit 707 of the determined notification details. The notification details include, for example, information on the bed number, the determination result, and the notification level.

In step S1313, the notification control unit 707 of the information processing apparatus 101 notifies the predetermined notification destination (for example, the nurse call system 121) of the user information including the notification details determined by the determination unit 706. This step corresponds to the step S1206 in FIG. 12.

In step S1314, the nurse call system 121 causes, for example, the information terminal 123, the display device 122, or the like to display a display screen based on the user information notified from the information processing apparatus 101.

Example of Display Screen

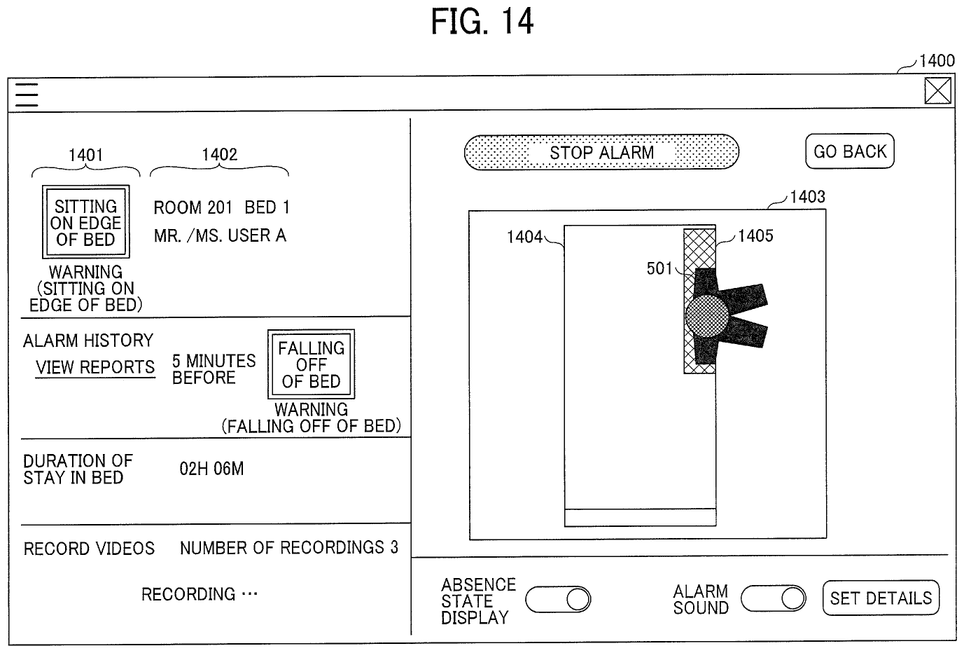

FIG. 14 is a diagram illustrating an example of a display screen according to the first embodiment. FIG. 14 is an illustration of a display screen 1400 that is displayed on the information terminal 123, the display device 122, or the like. The nurse call system 121 causes, for example, the information terminal 123, the display device 122, or the like to display the display screen 1400 based on the user information notified from the information processing apparatus 101.

In the example of FIG. 14, on the display screen 1400, state information 1401 indicating a state of the user 501, information 1402 indicating a hospital room, a bed, a name, etc. of the user 501, and an image (user image) 1403 including an image of the user 501. As described above, the state of the user is determined by the information processing apparatus 101.

In the example of FIG. 14, in the state information 1401 indicating the state of the user 501, the warning information indicating that the state of the user 501 is the “sitting on edge of bed”. This information is displayed, for example, based on the user information notified from the information processing apparatus 101.

The information 1402, which indicates the hospital room, bed, name, etc. of the user 501, is generated, by the nurse call system 121, based on the bed number notified from the information processing apparatus 101 and patient information managed by the nurse call system 121, for example.

As the user image 1403, for example, a temperature image of the user 501 based on the image data of the user 501 captured by the camera 102 in step S1301 of FIG. 13 is displayed. Further, in the user image 1403, a display element 1404 indicating the position of the bed 103 may be displayed in order to facilitate grasping the positional relationship of the user 501. Further, the user image 1403 may display another display element 1405 indicating a detection area in which the predetermined temperature is detected.

The display screen 1400 allows, for example, a staff of a medical facility to easily recognize that the user 501 is in the state of “sitting on edge of bed”.

### Second Embodiment

The embodiment described above is an example, and the information processing system 100 may be applied and modified in various ways.

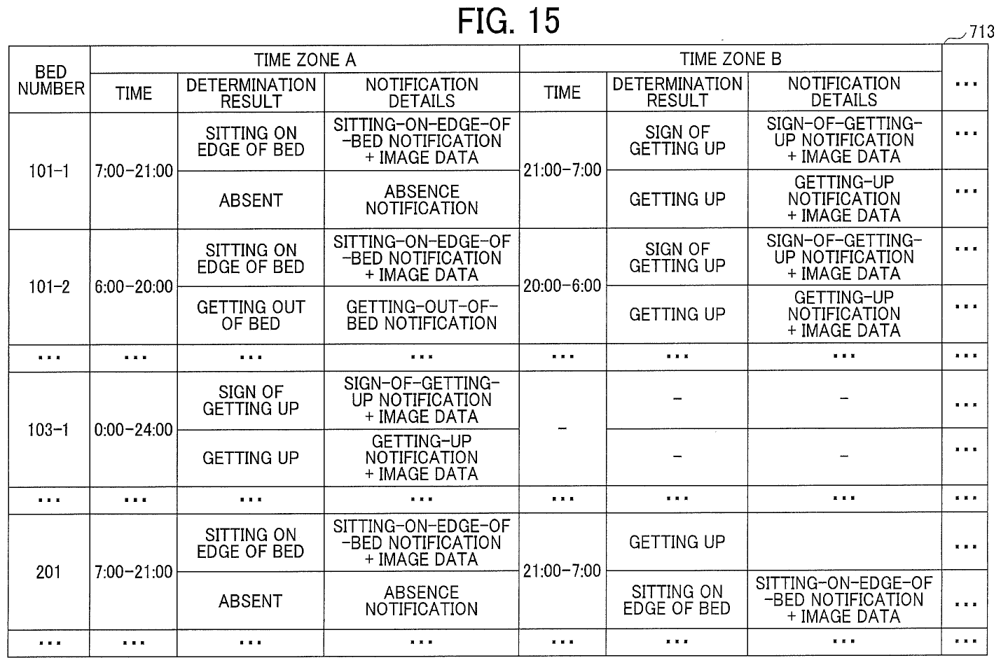

FIG. 15 is a diagram illustrating an example of a table of the setting information according to a second embodiment. The setting information 713 of the example of FIG. 15 is different from the setting information 713 of FIG. 9B in including the information on “notification details” instead of the information on “notification level”.

For example, in the time zone A for the bed number “1014” in the setting information 713 illustrated in FIG. 15, the notification details of “sitting-on-edge-of-bed notification and (+) image data” is stored in association with the determination result of “sitting on edge of bed”. Similarly, in the time zone A for the bed number “101-1”, the notification details of “absent notification” is stored in association with the determination result of “absent”. In the description of the present embodiment, for an information item of “notification details”, another example of information on the notification details according to a combination of the time zone and the determination result is used, or set.

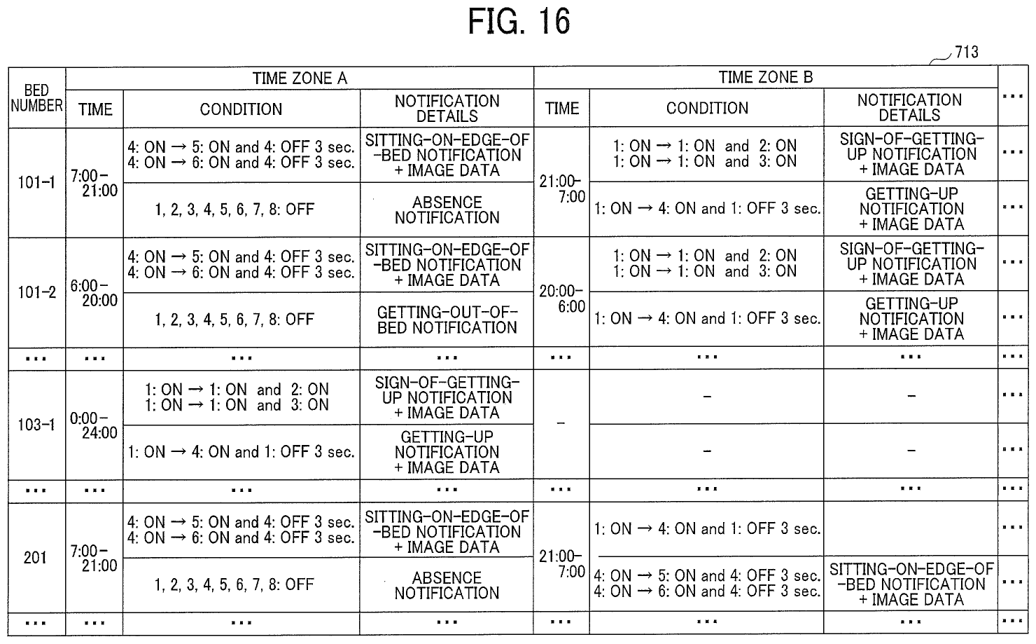

FIG. 16 is a diagram illustrating an example of the setting information according to a second embodiment. The setting information 713 of the example of FIG. 16 is different from the setting information 713 of FIG. 9B in including the information on “determination condition” instead of the information on “determination result”. In the description of the present embodiment, for an information item of “determination condition”, another example of information on the determination condition is used, or set, in each time zone.

As described above, the information included in the setting information 713 is variously modifiable.

Processes

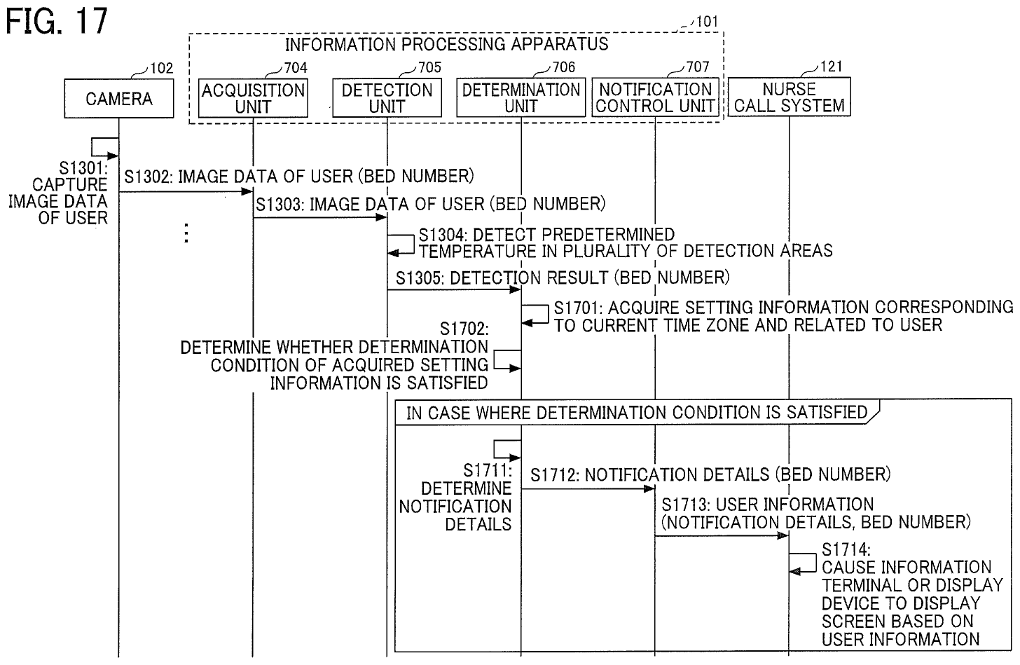

FIG. 17 is a sequence diagram illustrating an example of a process performed by the information processing system 100 according to a second embodiment. This process is performed by the information processing system in a case where the information processing apparatus 101 has the setting information 713 as illustrated. in FIG. 15 or FIG. 16. The steps S1301 to S1305 in FIG. 17 are the substantially the same as those illustrated in the sequence diagram of FIG. 13, which is performed by the information processing system 100 according to the first embodiment. Accordingly, a redundant description thereof is omitted below, and a description is given mainly of differences between the second embodiment and the first embodiment.

In step S1701, the determination unit 706 of the information processing apparatus 101 acquires the setting information of the user 501 corresponding to a current time zone. For example, the determination unit 706 acquires information including the bed number corresponding to the one in the image data of the user 501, information on the “determination result(s)” and “notification details” corresponding to the current time, based on the setting information 713 as illustrated in FIG. 15. Alternatively, the determination unit 706 acquires information including the bed number corresponding to the one in the image data of the user 501, information on the “determination condition(s)” and “notification details” corresponding to the current time, based on the setting information 713 as illustrated in FIG. 16.

In step S1702, the determination unit 706 determines whether the predetermined temperature detected by the detection unit 705 satisfies the determination condition of the acquired setting information. For example, the determination unit 706 acquires the determination condition corresponding to the “determination result” acquired from the setting information 713 as illustrated in FIG. 15 from the determination information 712 as illustrated in FIG. 8C, and determines whether the predetermined temperature, which is detected by the detection unit 705, satisfies the acquired determination condition. Alternatively, the determination unit 706 determines whether the predetermined temperature detected by the detection unit 705 satisfies the “determination condition” acquired from the setting information 713 as illustrated in FIG. 16.

In response to a determination indicating that the predetermined temperature detected by the detection unit 705 satisfies the determination condition of the acquired setting information, the processes of steps S1711 to S1714 are performed.

In step S1711, the determination unit 706 determines the notification details of the user information to be notified to the predetermined notification destination. For example, when the determination unit 706 acquires the “determination result” and the “notification details” from the setting information 713 as illustrated in FIG. 15, the determination unit 706 determines, as content of the notification corresponding to the user information; the “notification details” corresponding to the “determination result” that satisfies the determination condition. Alternatively, for example, when the determination unit 706 acquires the “determination condition” and the “notification details” from the setting information 713 as illustrated in FIG. 16, the determination unit 706 determines, as content of the notification corresponding to the user information, the “notification details” corresponding to the “determination condition” that satisfies the determination condition.

In step S1712, the determination unit 706 notifies the notification control unit 707 of the determined notification details. The notification details includes the identification information such as a bed number.

In step S1713, the notification control unit 707 of the information processing apparatus 101 notifies the nurse call system 121 of the user information including the notification details determined by the determination unit 706 and the bed number. When the notification details determined by the determination unit 706 includes “image data”, the notification control unit 707 acquires the image data of the user 501 corresponding to the bed number from the storage unit 709 and notifies the nurse call system 121 of the user information including the acquired image data of the user 501.

In step S1714, the nurse call system 121 causes, for example, the information terminal 123, the display device 122, or the like to display a display screen based on the user information notified from the information processing apparatus 101.

The information processing apparatus 101 according to the embodiments described above, manages, for each bed 103 (for each user 501), the setting information 713 as illustrated in FIG. 9A, FIG. 9B, FIG. 15 or FIG. 16.

According to the embodiments described above, the information processing system 100, which notifies a predetermined notification destination of a state of the user 501 by using image data of the user 501, facilitates notifying a notification destination of necessary information according to an activity pattern of each user 501.

For example, regarding information processing systems with the conventional technology, information on a state of a user is desired to be notified to a predetermined notification destination according to an activity pattern of each user.

For example, when a user is a patient hospitalized in a medical facility, the user may get up from the bed during the day and do various activities such as watching a TV, reading a book, and eating. Accordingly, in a case the information processing system with the conventional technology detects that the user gets up during the day and notifies the predetermined notification destination of a detection result, resulting in increment of unnecessary notifications.

On the other hand, when a state of the user of getting up at night or of indicating a sign of getting up is detected, the user may take an action that requires caution, such as going to a bathroom or wandering around. Accordingly, such a detection result is desired to be notified to the predetermined notification destination, depending on the user.

In addition, some of the users have difficulty to get up by themselves and do not want to get up by themselves (for example, patients who have just awakened from anesthesia after surgery). Due to this reason, even during the daytime, there is a case where the user information is desired to be notified to the predetermined notification destination indicating that the user is in the state of indicating a “sign of getting up”, for example.

In the conventional technology, the information processing system, which notifies a predetermined notification destination of a state of a user by using image data of the user, has difficulty to determine whether to transmit information on the user to a notification destination according to an activity pattern for each user.

In addition, note that the description given above related to the bed is not limiting, but the bed may be replaceable with one of various types of facilities (a piece of equipment) on which the user is able to lie down in substantially the same manner as the user lies down on the bed. An example of such a facility (a piece of equipment) may be a stretcher, an operating table, or an examination table in a facility such as a medical facility or a nursing facility.

According to some embodiments of the present disclosure, the information processing system, which notifies a predetermined destination of a state of the user by using image data of the user, facilitates notifying a notification destination of necessary information according to an activity pattern of each user.

Each of the functions of the described embodiments can be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

The apparatuses and the like described in the examples are merely an illustration of one of several computing environments for implementing the embodiments disclosed herein. In some embodiments, information processing apparatus 101 includes multiple computing devices, such as a server cluster. The multiple computing devices are configured to communicate with one another through any type of communication link including a network, shared memory, etc., and perform the processes described in this disclosure. Similarly, the nurse call system 121 may include such multiple computing devices configured to communicate with one another.

Further, each of the information processing apparatus 101 and the nurse call system 121 can be configured to share the disclosed processing steps, for example, illustrated in FIG. 13, FIG. 14, or FIG. 18, in various combinations. For example, a process executed by a particular unit may be executed by the information processing apparatus 101. Similarly, the function of a particular unit can be executed by the nurse call system 121. The functions of the information processing apparatus 101 and the nurse call system 121 may be combined into one server or may be divided into a plurality of devices.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus, comprising:
circuitry configured to
acquire image data that is related to a user who uses a piece of equipment, the image data indicating a state of the user,
store, in a memory, setting information in which an item of time zone, an item of determination result, and an item of notification details are associated with each other, the item of time zone including one or more time zones for which the image data is captured, the item of determination result including one or more determination results in each of the one or more time zones, the item of notification details including notification details being set according to a combination of one of the one or more time zones and one of the one or more determination results, and
determine whether to transmit a notification related to the state of the user based on the image data and the setting information,
wherein, the circuitry further configured to determine the notification details based on the image data and the setting information in response to a determination result indicating to transmit the notification.

2. The information processing apparatus of claim 1,
wherein the circuitry transmits the notification to a notification destination according to the notification details.

3. The information processing apparatus of claim 1,
wherein, the image data includes temperature image data that indicates temperature of the piece of equipment, which is used by the user, and an area around the piece of equipment.

4. The information processing apparatus, of claim 1,
wherein the piece of equipment includes a bed, which is used by the user, and
wherein the determination result includes information on the state of the user.

5. The information processing apparatus of claim 1,
wherein the circuitry further configured to
detect, using the image data, a predetermined temperature corresponding to the user in a plurality of detection areas set in a detection range, the detection range including the piece of equipment and an area around the piece of equipment, and
manage, in the memory, the determination result indicating the state of the user according to detected information, the detected information being one of information on at least one of the plurality of detection areas and information indicating changes of the at least one of the plurality of detection areas, the at least one of the plurality of detection areas being at least one area from which the predetermined temperature has been detected.

6. The information processing apparatus of claim 5,
wherein the image data is divided into a plurality of sub-areas, and each of the plurality of detection areas being corresponding to a set of one or more of the plurality of sub-areas.

7. The information processing apparatus of claim 1,
wherein the notification details includes information on levels for importance, urgency, and priority each of which is related to the determination result.

8. An information processing system, comprising
an information processing apparatus including first circuitry;
a camera; and
a communication device including second circuitry,
the first circuitry being configured to
acquire image data that is related to a user who uses a piece of equipment, the image data indicating a state of the user,
store, in a memory, setting information in which an item of time zone, an item of determination result, and an item of notification details are associated with each other, the item of time zone including one or more time zones for which the image data is captured, the item of determination result including one or more determination results in each of the one or more time zones, the item of notification details including notification details being set according to a combination of one of the one or more time zones and one of the one or more determination results, and
determine whether to transmit a notification related to the state of the user based on the image data and the setting information,
wherein, the first circuitry further configured to determine the notification details based on the image data and the setting information in response to a determination result indicating to transmit the notification,
the camera being configured to
capture the image data, and
transmit the image data to the information processing apparatus, and
the second circuitry being configured to receive the notification from the information processing apparatus.

9. A method of providing information, comprising:
acquiring image data that is related to a user who uses a piece of equipment, the image data indicating a state of the user;
storing, in a memory, setting information in which an item of time zone, an item of determination result, and an item of notification details are associated with each other, the item of time zone including one or more time zones for which the image data is captured, the item of determination result including one or more determination results in each of the one or more time zones, the item of notification details including notification details being set according to a combination of one of the one or more time zones and one of the one or more determination results; and
determining whether to transmit a notification related to the state of the user based on the image data and the setting information,
wherein, the method further comprising, in a case where the determining determines to transmit the notification, determining the notification details based on the image data and the setting information.

10. A non-transitory recording medium storing a plurality of instructions which, when executed by one or more processors, cause the processors to perform the method of claim 9.
